(19) United States
(12) Patent Application Publication
(10) Pub. No.: US 2007/0180032 A1
(43) Pub. Date: Aug. 2, 2007

(54) Method for email service in a visual voicemail system

(75) Inventor: Larry B. Pearson, San Antonio, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/342,210

(22) Filed: Jan. 27, 2006

(51) Int. Cl. G06F 15/16

(52) U.S. Cl. 709/206

(57) ABSTRACT

A system and method are disclosed for an email service in a visual voicemail system (VVM) (110). A system that incorporates teachings of the present disclosure may include a VVM having a controller (102) coupled to a communication network (101) that manages operations of the VVM, populates (304) an end user profile as directed by an end user, records (306) a voicemail supplied by a calling party, stores the voicemail, populates (308) a “To” field of SMTP headers with a forwarding email address of the end user profile, populates (310) a “From” field of the SMTP headers with an email address of the VVM, populates (312) a “Reply to” field of the SMTP headers with a reply email address of the end user profile, generates (314) an email with the foregoing SMTP headers, a file corresponding to the voicemail, and instructions for disabling further forwarding of voicemails, and transmits (316) the email to the forwarding email address. Additional embodiments are disclosed.

### FIELD OF THE DISCLOSURE

The present disclosure relates generally to visual voicemail systems, and more specifically to a method for email service in a visual voicemail system.

### BACKGROUND

Unified messaging systems (UMS) provide end users access to voicemail by way of a public switched telephone network (PSTN), an IP interface such as a website, and email service. A UMS generally assigns an email address for each end user. Because of the inflexibility of a UMS to allow end user's to define their own email addresses, it is common for end users to manage more than one email address (e.g., personal, business, and a UMS email address). A visual voicemail system (VVM) differs from a UMS in that it provides PSTN or website access to voicemail without email services. A need therefore arises for email services in a visual voicemail system with greater flexibility than is offered today by a UMS.

### BRIEF DESCRIPTION OF THE DRAWINGS

FIG. 1 depicts an exemplary embodiment of a visual voicemail system (VVM), an email exchange server (EXS), and a number of communication devices operating in a communication system;

FIG. 2 depicts an exemplary embodiment of the communication devices;

FIG. 3 depicts an exemplary method operating in the VVM;

FIG. 4 depicts an exemplary method operating in the EXS;

FIG. 5 depicts an exemplary method operating in the communication devices; and

FIG. 6 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method for email service in a visual voicemail system (VVM).

In a first embodiment of the present disclosure, a visual voicemail system (VVM) having a controller coupled to a communication network for managing operations of a voicemail service of the VVM. The controller is programmed to populate an end user profile as directed by an end user, wherein the end user profile comprises a reply email address and a notification or forwarding email address, record a voicemail supplied by a calling party, store the voicemail, populate a “To” field of SMTP (simple mail transfer protocol) headers with the notification or forwarding email address of the end user profile, populate a “From” field of the SMTP headers with an email address associated with the VVM, populate a “Reply to” field of the SMTP email headers with the reply email address of the end user profile, generate an email with the foregoing SMTP headers, a voicemail notification message or an attached file corresponding to the voicemail, and instructions in the email for disabling voicemail notifications directed to the notification email address or forwarding of voicemails to the forwarding email address, and transmit the email to a recipient associated with the notification or forwarding email address.

In a second embodiment of the present disclosure, an email exchange server (EXS) has a controller that manages email exchanges in a communication network. The controller can be programmed to receive an email from a VVM that includes a voicemail file, a forwarding email address in a “To” field of SMTP headers directed to a communication device, a VVM email address in a “From” field of the SMTP headers, and a reply email address in a “Reply to” field of the SMTP headers, wherein each of the forwarding and reply email addresses is derived from an end user profile associated with the VVM. The controller can also be programmed to determine from a TCP/IP connection an IP address associated with an originator of the email, determine a domain name associated with the IP address, compare the domain name of the IP address with a domain name of the VVM email address, if the domain names do not match, ignore and discard the email, and if the domain names match, forward the email to the communication device according to the forwarding email address.

In a third embodiment of the present disclosure, a communication device has a controller that manages operations of a transceiver coupled to a communication network. The controller can be programmed to receive an email from a visual voicemail system (VVM) comprising a voicemail file, one or more instructions for disabling forwarding of voicemails to the communication device, a forwarding email address in a “To” field of email headers directed to the communication device, a VVM email address in a “From” field of the email headers, and a reply email address in a “Reply to” field of the email headers, wherein each of the forwarding and reply email addresses is derived from an end user profile associated with the VVM. The controller can also be programmed to receive from an end user of the communication device a request to reply to the email according to the reply email address, or a request to disable forwarding of voicemails according to the one or more instructions supplied by the end user.

In a fourth embodiment of the present disclosure, a computer-readable storage medium operates in a VVM. The storage medium can have computer instructions for recording a voicemail supplied by a calling party, storing the voicemail, populating a “To” field of SMTP headers with a forwarding email address of an end user profile, populating a “From” field of the SMTP headers with an email address associated with the VVM, populating a “Reply to” field of the SMTP email headers with a reply email address of the end user profile, generating an email with the foregoing SMTP headers, and an attached file corresponding to the voicemail, and transmitting the email to a recipient associated with the forwarding email address.

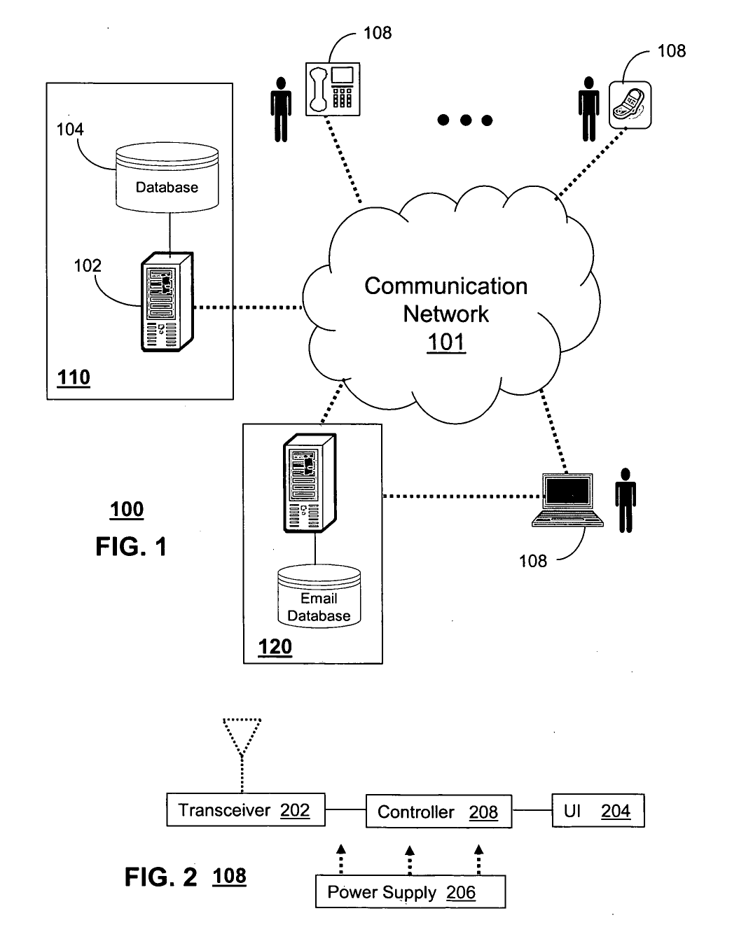

FIG. 1 depicts an exemplary embodiment of a visual voicemail system (VVM) 110, an email exchange server (EXS) 120, and a number of communication devices 108 operating in a communication system 100. The VVM 110 comprises a communications interface, a memory 104 and a controller 102. The communications interface utilizes wired or wireless communications technology for interfacing to a communication network 101. The communications interface can represent a circuit switched and/or a packet switched interface to the communication network 101.

The controller 102 utilizes computing technology such as a desktop computer, or a scalable server. The memory 104 utilizes mass storage media such as a high capacity disk drive that can be used by the controller 102 to manage one or more databases in accordance with the present disclosure. The VVM 110 can also use software applications such as a voicemail service that provides end users a means for storing and forwarding voicemail records to any email address, an IVR (Interactive Voice Response) application for interacting with end users, a website application for presenting a selectable graphical user interface (GUI) to end users, and/or a CRM (Customer Relations Management) application for managing customer account information.

The EXS 120 comprises a controller and database for managing emails of a number of end users of a mid to large commercial enterprise. The EXS can, for example, embody a Linux or Microsoft™ exchange server. The EXS 120 can exchange emails with third parties by way of an Intra or Extranet portion of the communication network 101.

The communication devices 108 can have several embodiments as shown in FIG. 1. In a first embodiment, the communication device 108 can represent a Voice over IP (VoIP) handset. Alternatively, the communication device 108 can be represented by a wireless handset such as a cellular phone or WiFi handset. In yet another embodiment, the communication device 108 can represent a computing device such as a desktop or laptop computer with the ability to interface to the communication network 101. According to any one of these embodiments, the communication device 108 can thus receive and respond to emails by way of the communication network 101, or in a commercial setting by way of the EXS 120 in an Intranet or Extranet portion of the communication network 101.

The communication devices 108 can utilize a wired or wireless-transceiver 202 for interfacing to the communication network 101. The communication device 108 can further include a user interface (UI) 204, a power supply 206 and a controller 208. The transceiver 202 can utilize common wireless technology such as cellular (e.g., GSM, CDMA, UMTS, etc.), WiFi, Bluetooth™, and/or WiMax technologies. Alternatively, the transceiver 202 can singly or in combination support wireline technology such as PSTN (Public Switched Telephone Network), Ethernet, DSL or cable. The UI 204 can include a common display such as a liquid crystal display for conveying images to an end user of the communication device 108, a keypad with navigation keys for manipulating operations of the communication device 108, and an audio system for exchanging audible signals with the end user. The power supply 206 can be used for portable applications where mobility is desired. The controller 208 can include computing technology such a microprocessor and/or digital signal processor (DSP) for managing operations of the communication device 108.

The communication network 101 can offer multiple services such as POTS (Plain Old Telephone Service), VoIP (Voice over Internet Protocol), IPTV (Internet Protocol Television), broadband communications, cellular telephony, and other known or future communication services.

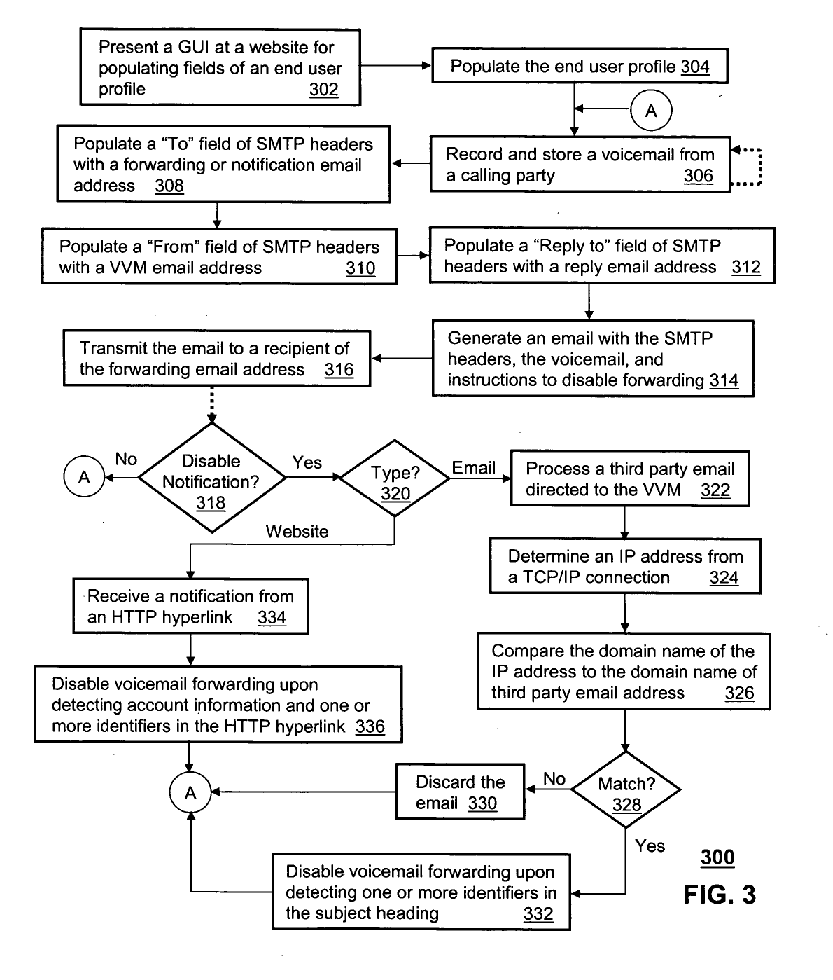

FIG. 3 depicts an exemplary method 300 operating in the VVM 110. Method 300 begins with step 302 where the controller 102 of the VVM 110 presents a GUI at a website application hosted by the VVM 110. The website application provides an end user the means to populate fields of an end user profile in step 304. The end user profile can store among other things a notification email address, a forwarding email address, a reply email address, and settings for enabling or disabling forwarding of voicemails. The notification email address can direct the VVM 110 to send notification messages to a recipient corresponding to the notification email address when voicemail has been recorded from a calling party. The forwarding email address, on the other hand, can direct the VVM 110 to forward voicemail files automatically to the recipient of the forwarding email address as voicemail messages are recorded by a calling party. The reply email address can be used by the recipient of the forwarding email address for responding to voicemail messages received from the VVM 110.

Alternatively, the end user profile can be populated by way of a common IVR system operating in the VVM 110. Accordingly, the controller 102 can be programmed with common voice recognition software to receive instructions from the end user to populate fields and settings in the end user profile.

Once the end user profile has been defined by the end user by way of the website application or the IVR, the controller 102 can be programmed to record and store voicemails from a calling parties by common means when the end user does not respond to a call from said calling parties. If voicemail notification or forwarding is enabled, the controller 102 proceeds to step 308; otherwise, the controller 102 remains in step 306. In step 308, the controller 102 can be programmed to populate a “To” field in SMTP (simple mail transfer protocol) headers of an email with the forwarding email address. In step 310, the controller 102 can be programmed to populate a “From” field of SMTP headers with a VVM email address, and a “Reply to” field of SMTP headers with a reply email address. The forwarding email address can be any conventional email address selected by the end user. The end user profile can be programmed with more than one forwarding email address. Accordingly, the controller 102 can forward voicemails to one or many recipients.

The reply email address can be used by the recipient for replying to voicemail messages to an email address other than the VVM 110 email address. The recipient of the forwarded voicemail may see the “From” field with only the email address of the VVM 110, or a format such as <the email address of the VVM 110> “on behalf of” <the email address in the “Reply to” field>. Accordingly, the “Reply to” field may be hidden until such time that the recipient decides to reply to the voicemail message, or it may be indirectly displayed in the “From” field using an “on behalf” format such as described above. With either format, reply messages can be directed to parties other than the VVM 110. More than one reply email address can also be defined in the end user profile in which case replies can be directed to one or more parties.

Once the SMTP headers have been populated, the controller 102 proceeds to step 314 where it generates an email with the SMTP headers, a file corresponding to the voicemail recorded in step 306 in any suitable file format (e.g., WAV file or otherwise), and instructions for the recipient of the email to disable further forwarding of voicemails. The controller 102 proceeds to step 316 where it transmits the email to the recipient of the forwarding email address. The email can be directed to any of the embodiments of the communication devices 108 of FIG. 1. The recipient can be the same person as the end user who populated the end user profile or another party.

The instructions can include a means for disabling voicemail forwarding by way of an email submitted to the VVM 110 or by selecting an HTTP hyperlink included in the email of step 316. In the former case, the instructions can direct the recipient to forward an email to a specific address of the VVM 110 (which may or may not be the same as the VVM email address of step 310). The instructions can further request the recipient to include in the email one or more identifiers such as account information of the end user and a request for disabling voicemail forwarding. The VVM address used for disabling voicemail forwarding can be, for example, a generic email address such as email-service@vvm.xyz_service.com, or an email address with the end user's account information 2223334444@vvm.xyz_service.com. For the latter email address, the end user need not include account information in another portion of the email. The end user can further include text to disable voicemail forwarding such as “disable” or “disable voicemail” in the subject heading or body of the email.

In a background process, the controller 102 checks in step 318 for a notification from the recipient of the email in step 316 to disable further forwarding of voicemails to said recipient. While the controller 102 awaits a notification, it continues to process and forward voicemails to the recipient in steps 306-316. Once a notification is detected, the controller 102 proceeds to step 320 where it checks the type of notification received. If notification is by way of an email, the controller 102 proceeds to step 322 where it processes a third party email directed to the VVM 110.

To eliminate spam emails, the controller 102 proceeds to step 324 where it determines using common techniques an IP address and a corresponding domain name from a TCP/IP connection from which the third party email was received. In step 326, the controller 102 compares the domain name of the IP address to the domain name of the third party email address. If no match is detected in step 328, the controller 102 proceeds to step 330 where it discards the third party email as spam email. Otherwise, the controller 102 proceeds to step 332 where it disables voicemail forwarding upon detecting the aforementioned identifiers (e.g., text such as “disable” in the subject heading of the third party email and end user account information). From steps 330-332, the controller 102 proceeds to step 306 where it continues to receive and record voicemails. If voicemail forwarding was disabled in step 332, the controller 102 remains in step 306; otherwise, it forwards voicemails by email in steps 308-316 as described earlier.

Alternatively, notification for disabling voicemail forwarding can occur from a selection of an HTTP hyperlink associated with the website application hosted by the VVM 110. From step 320, the controller 102 proceeds to step 334 where it receives notification from an HTTP hyperlink selected by the recipient of the email transmitted in step 316. In step 336, the controller 102 disables voicemail forwarding upon detecting account information and one or more identifiers in the HTTP hyperlink. The following is a sample hyperlink that can serve as a means for disabling voicemail forwarding: http://vvm.xyz_service.com/Disable?from=“2223334444”&to=recipient@xxx.com.

Once disabled, the controller 102 proceeds to step 306 and remains there until such time that the end user enables voicemail forwarding by way of the website application or IVR application operating in the VVM 110.

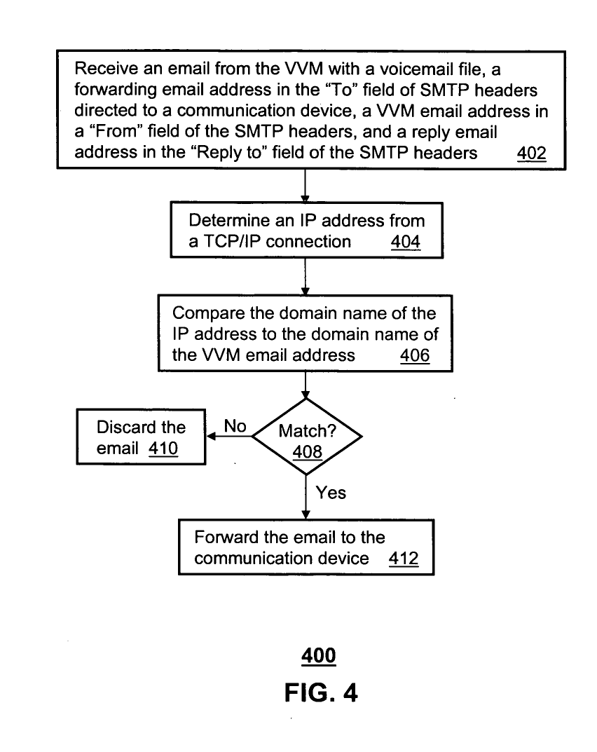

FIG. 4 depicts an exemplary method 400 operating in the EXS 120. The EXS 120 can be utilized in a mid to large sized enterprise for managing employee emails in a commercial setting. Method 400 begins with step 402 where the controller of the EXS 120 receives an email from the VVM 110. The email includes a voicemail file, a forwarding email address in the “To” field of SMTP headers directed to a communication device 108, a VVM email address in a “From” field of the SMTP headers, a reply email address in the “Reply to” field of the SMTP headers, and instructions for disabling voicemail forwarding to the recipient of the communication device 108. As a means to eliminate spam email, the EXS 120 proceeds to step 404 where it determines an IP address and corresponding domain name from a TCP/IP connection from which the email was received. In step 406, the EXS 120 compares the domain name of the IP address to the domain name of the VVM email address. If no match is detected in step 408, the EXS 120 proceeds to step 410 where it discards the email as spam email. Otherwise, the EXS 120 proceeds to step 412 where it forwards the email to the communication device 108.

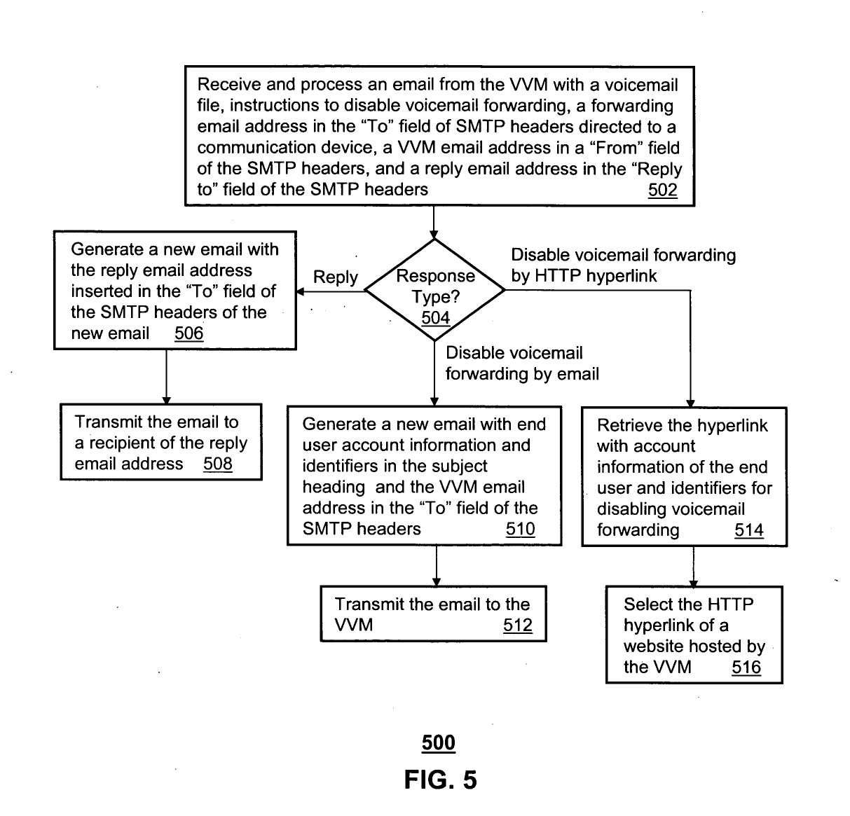

FIG. 5 depicts an exemplary method 500 operating in the communication devices. Method 500 begins with step 502 where the controller 208 of the communication device 108 receives by way of the transceiver 202 by wireline or a wireless medium an email from the VVM 110 (or EXS 120). The email can include a voicemail file, instructions for disabling voicemail forwarding, a forwarding email address in the “To” field of SMTP headers targeting the communication device 108 as the recipient of the email, a VVM email address in a “From” field of the SMTP headers, and a reply email address in the “Reply to” field of the SMTP headers. The end user of the communication device 108 can direct the controller 208 to process and play the voicemail message included in the file by way of the UI 204 using common software techniques.

The controller 208 in step 504 can provide the end user a means for responding to the voicemail message, and one of two options to disable further voicemail forwarding. If the end user chooses to reply to the voicemail message, the controller 208 proceeds to step 506 where it generates a new email with the reply email address inserted in the “To” field of the SMTP headers. The reply email address is taken from the “Reply to” field of the SMTP headers of the email received in step 502. As noted earlier this email address is defined in the end user profile stored by the VVM 110. The new email of step 506 can include a message drafted by the end user by way of the UI 204 and the voicemail file if directed by the end user. Once the email is constructed, the controller 208 directs the transceiver 202 in step 508 to transmit the new email to a recipient associated with the reply email address.

The end user can singly or in combination with the reply steps 506-508 choose to disable voicemail forwarding in accordance with the instructions provided in the email of step 502. As discussed earlier, the VVM 110 can provide instructions for disabling voicemail forwarding by way of an email and/or selection of an HTTP hyperlink associated with a website application hosted by the VVM 110. In the case of the email option, the controller 208 can generate in step 510 a new email with end user account information (such as the end user's phone number) in the subject heading or body of the email, and one or more identifiers in the subject heading (e.g., “disable”), and the VVM email address in the “To” field of the SMTP headers of the email. In step 512, the controller 208 transmits the email to the VVM 110.

Alternatively, the controller 208 can proceed to step 514 where it retrieves from the email of step 502 the HTTP hyperlink which includes one or more identifiers such as the end user's account information and a request to disable voicemail forwarding much like the hyperlink example provided above. In step 516, the end user selects the HTTP hyperlink by way of the UI 204 thereby submitting a notification to the VVM 110 to disable voicemail forwarding by way of the website application hosted by the VVM 110.

Although not shown the controller 208 can also be programmed to check for spam email prior to step 504 in a manner similar to the steps described in FIGS. 3-4.

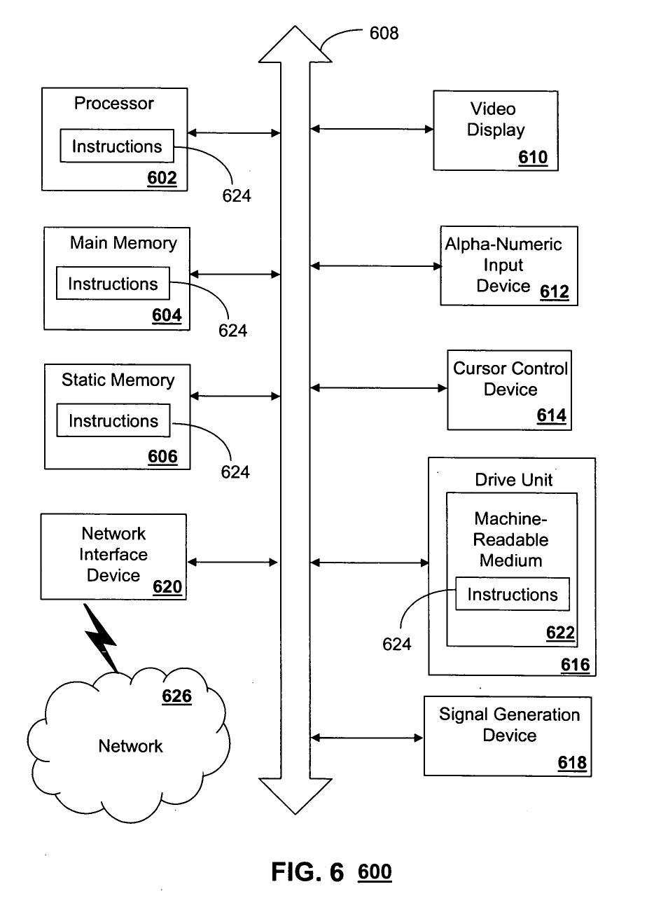

FIG. 6 depicts an exemplary diagrammatic representation of a machine in the form of a computer system 600 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU, or both), a main memory 604 and a static memory 606, which communicate with each other via a bus 608. The computer system 600 may further include a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface device 620.

The disk drive unit 616 may include a machine-readable medium 622 on which is stored one or more sets of instructions (e.g., software 624) embodying any one or more of the methodologies or functions described herein, including those methods illustrated above. The instructions 624 may also reside, completely or at least partially, within the main memory 604, the static memory 606, and/or within the processor 602 during execution thereof by the computer system 600. The main memory 604 and the processor 602 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A visual voicemail system (VVM), comprising:
a controller coupled to a communication network, wherein the controller manages operations of a voicemail service of the VVM, wherein the controller is programmed to:
populate an end user profile as directed by an end user, wherein the end user profile comprises a reply email address and a notification or forwarding email address;
record a voicemail supplied by a calling party;
store the voicemail;
populate a “To” field of SMTP (simple mail transfer protocol) headers with the notification or forwarding email address of the end user profile;
populate a “From” field of the SMTP headers with an email address associated with the VVM;
populate a “Reply to” field of the SMTP email headers with the reply email address of the end user profile;
generate an email with the foregoing SMTP headers, a voicemail notification message or an attached file corresponding to the voicemail, and instructions in the email for disabling voicemail notifications directed to the notification email address and for disabling forwarding of voicemails to the forwarding email address; and
transmit the email to a recipient associated with the notification or forwarding email address.

2. The VVM of claim 1, comprising a website application hosted by the VVM, or an interactive voice response system (IVR), wherein the controller is programmed to interact with the end user for populating the end user profile according to the website application, or the IVR.

3. The VVM of claim 1, wherein the instructions comprise a means for disabling notification of voicemails to the notification email address or forwarding of voicemails to the forwarding email address according to a third party email submitted to the VVM with one or more identifiers that direct the VVM to disable voicemail notification or voicemail forwarding.

4. The VVM of claim 3, wherein the one or more identifiers are included in the subject heading of the third party email.

5. The VVM of claim 2, wherein the instructions comprise a means for disabling notification of voicemails to the notification email address or forwarding of voicemails to the forwarding email address according to an HTTP hyperlink associated with the website application.

6. The VVM of claim 1, wherein the controller is programmed to:
process a third party email directed to the VVM; and
disable notification of voicemails to the notification email address or forwarding of voicemail to the forwarding email address upon detecting one or more identifiers in the third party email.

7. The VVM of claim 6, wherein the one or more identifiers comprise account information associated with the end user, and an instruction to disable voicemail notification or voicemail forwarding.

8. The VVM of claim 1, wherein the controller is programmed to:
receive a notification by way of an HTTP hyperlink associated with the website application;
disable voicemail notifications to the notification email address or voicemail forwarding to the forwarding email address upon detecting in the HTTP hyperlink account information associated with the end user and one or more identifiers.

9. The VVM of claim 1, wherein the controller is programmed to:
receive a third party email directed to the VVM;
determine from a TCP/IP connection an IP address associated with an originator of the third party email;
determine a domain name associated with the IP address;
compare the domain name of the IP address with a domain name of the third party email address;
if the domain names do not match, ignore and discard the email; and
if the domain names match, disable notifications directed to the notification email address or forwarding of voicemail to the forwarding email address upon detecting one or more identifiers in the third party email.

10. An email exchange server (EXS), comprising:
a controller that manages email exchanges in a communication network, wherein the controller is programmed to:
receive an email from a visual voicemail system (VVM) comprising a voicemail file, a forwarding email address in a “To” field of SMTP headers directed to a communication device, a VVM email address in a “From” field of the SMTP headers, and a reply email address in a “Reply to” field of the SMTP headers, wherein each of the forwarding and reply email addresses is derived from an end user profile associated with the VVM;
determine from a TCP/IP connection an IP address associated with an originator of the email;
determine a domain name associated with the IP address;
compare the domain name of the IP address with a domain name of the VVM email address;
if the domain names do not match, ignore and discard the email; and
if the domain names match, forward the email to the communication device according to the forwarding email address.

11. A communication device, comprising:
a controller that manages operations of a transceiver coupled to a communication network, wherein the controller is programmed to:
receive an email from a visual voicemail system (VVM) comprising a voicemail file, one or more instructions for disabling forwarding of voicemails to the communication device, a forwarding email address in a “To” field of email headers directed to the communication device, a VVM email address in a “From” field of the email headers, and a reply email address in a “Reply to” field of the email headers, wherein each of the forwarding and reply email addresses is derived from an end user profile associated with the VVM; and
receive from an end user of the communication device a request to reply to the email according to the reply email address, or disable forwarding of voicemails according to instructions supplied by the end user.

12. The communication device of claim 11, wherein the controller is programmed to generate and submit a second email with the reply email address inserted in the “To” field of the email headers of the second email in response to receiving from the end user the request to reply to the email.

13. The communication device of claim 11, wherein the one or more instructions comprise one or more identifiers for directing the VVM to disable voicemail forwarding, and wherein the controller is programmed to generate and submit to the VVM a second email that includes said identifiers in response to receiving from the end user the request to disable forwarding of voicemails.

14. The communication device of claim 13, wherein the one or more identifiers are included in the subject heading of the second email.

15. The communication device of claim 13, wherein the one or more instructions comprise a VVM email address, and wherein the controller is programmed to insert in a “To” field of the email headers of the second email the VVM email address.

16. The communication device of claim 13, wherein the one or more identifiers comprise account information associated with the end user, and an instruction to disable voicemail forwarding.

17. The communication device of claim 11, wherein the one or more instructions comprise a means for disabling forwarding of voicemails by way of a link of a website application hosted by the VVM, and wherein the controller is programmed to select the link of the website application.

18. The communication device of claim 17, wherein the controller is programmed to include in the link account information associated with the end user and one or more identifiers that direct the VVM to disable forwarding of voicemails to the forwarding address.

19. A computer-readable storage medium in a visual voicemail system (VVM), comprising computer instructions for:
recording a voicemail supplied by a calling party;
storing the voicemail;
populating a “To” field of SMTP headers with a forwarding email address of an end user profile;
populating a “From” field of the SMTP headers with an email address associated with the VVM;
populating a “Reply to” field of the SMTP email headers with a reply email address of the end user profile;
generating an email with the foregoing SMTP headers, and an attached file corresponding to the voicemail; and
transmitting the email to a recipient associated with the forwarding email address.

20. The storage medium of claim 19, comprising computer instructions for including in the email instructions for disabling forwarding of voicemails to the forwarding email address.

21. The storage medium of claim 19, comprising computer instructions for:
receiving a third party email directed to the VVM, or a notification by way of an HTTP hyperlink associated with a website application hosted by the VVM; and
disabling forwarding of voicemails to the forwarding email address upon detecting one or more identifiers and account information in the third party email, or one or more identifiers in the HTTP hyperlink.

22. The storage medium of claim 19, comprising computer instructions for presenting to an end user a graphical user interface (GUI) by way of a website application hosted by the VVM for entering the forwarding and reply email addresses of the end user profile.
